(19) United States
(12) Patent Application Publication
(10) Pub. No.: US 2010/0122958 A1
(43) Pub. Date: May 20, 2010

(54) Bicycle Parking Rack

(76) Inventor: David Tsai, Chang Hua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/270,954

(22) Filed: Nov. 14, 2008

(51) Int. Cl. B62H 3/06

(52) U.S. Cl. 211/22

(57) ABSTRACT

A bicycle parking rack comprises a base member provided on the ground and including a first flat portion and a second flat portion respectively defined at first and second ends thereof and attach the ground, and with a wheel of a bicycle disposed between the first and second flat portions; and a support member including a coupled portion formed on a first end thereof and detachably coupling to the base member and a holding portion formed on a second end thereof and extending from the coupled portion, and with the coupled portion provided between the first and second flat portions.

### BACKGROUND OF THE INVENTION

1. Field of the Invention

The present invention relates to a bicycle parking rack. More particularly, the present invention relates to a detachable bicycle parking rack for easy transport.

2. Description of the Related Art

Referring to Taiwan Patent No. M298556, it discloses that a parking rack 20 for a bicycle includes a base 21 and a first holding portion 22 disposed at the center of the base 21 and adapted for holding a tire of the bicycle during parking the bicycle in an upright position. A holding hole 23 is formed on and penetrates the holding portion 22. First and second end portions 24 and 25 extend from two ends of the base 21 respectively and are parallel to the ground. Two first anti-slip element 241 are provided on a side of the first end portion 24 toward the ground and two second anti-slip element 251 are provided on a side of the second end portion 25 toward the ground. A sign portion 26 is upward bent from the second end portion 25 and a second holding portion 27 extends from the sign portion 26 upwardly for holding wheel axle of the bicycle during parking the bicycle in an upright position for stable location of the bicycle.

However, the parking rack 20 is made from one-piece plate material and the bent portion between the sign portion 26 and the second end portion 25 is easy to be deformed during after repeated use and cannot exactly hold the wheel axle of the bicycle. Further, the parking rack 20 is not detachable and not convenient for transport.

The present invention will become clearer in light of the following detailed description of illustrative embodiment of this invention described in connection with the drawings.

### SUMMARY OF THE INVENTION

Aspects of the present invention address one or more of the issues mentioned above, thereby providing a bicycle parking rack. The bicycle parking rack includes a base member and a support member detachably coupled to the base member. While the bicycle parking rack is not in use, the support member can be detached from the base member for easy transport and storage. And the base member and the support member are formed via pressing a plate.

These and other aspects are addressed in relation to the Figures and related description.

### BRIEF DESCRIPTION OF THE DRAWINGS

The present invention will be described via detailed illustration of the preferred embodiment referring to the drawings.

FIG. 1 is a perspective view of a bicycle parking rack according to the preferred embodiment of the present invention.

FIG. 2 is an exploded view of the rack shown in FIG. 1.

FIG. 3 is a cross-sectional view taken along 3-3 in FIG. 1.

FIG. 4 is a cross-sectional view taken along 4-4 in FIG. 1.

FIG. 5 is a sketched, exploded view of the rack shown in FIG. 1, showing a plate pressed to form the base member and the support member of the rack.

FIG. 6 is a perspective view of a bicycle maintained in the rack shown in FIG. 1.

FIG. 7 is a back view of the bicycle and the rack shown in FIG. 6.

FIG. 8 is a perspective view of the bicycle parking rack shown in FIG. 1, illustrating that the support member received in the hollow portion of the base member when the bicycle parking rack is not in use.

### DETAILED DESCRIPTION OF THE PREFERRED EMBODIMENT

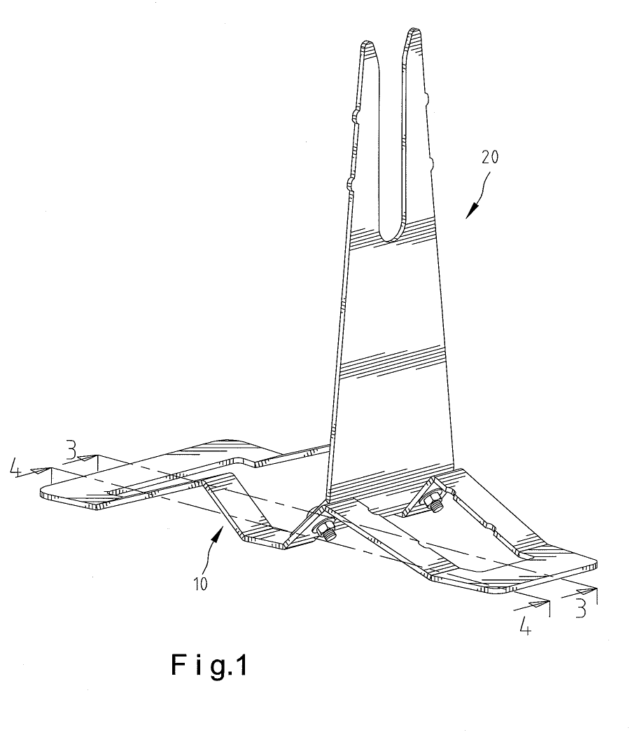

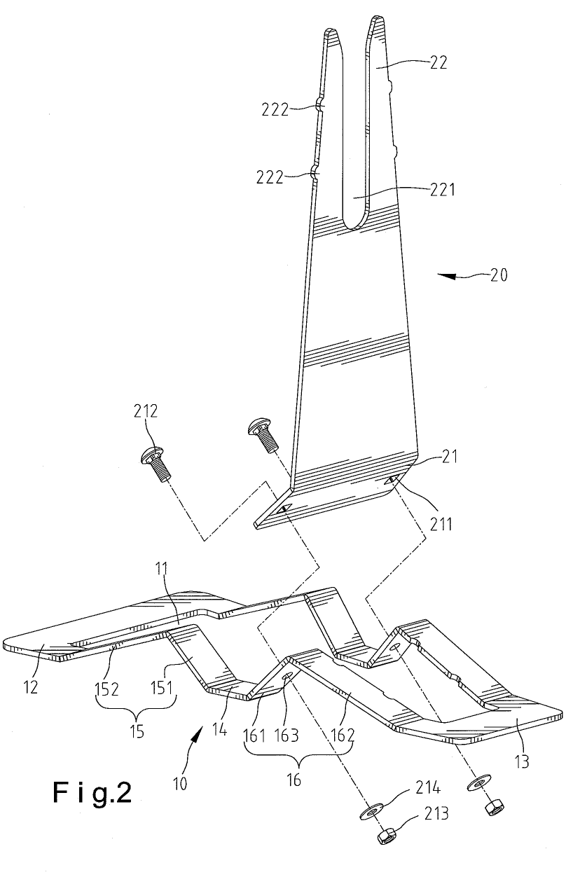

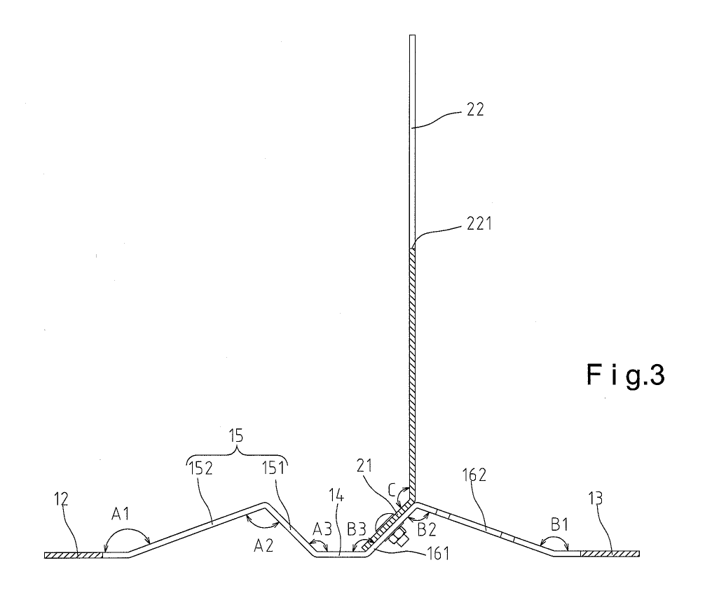

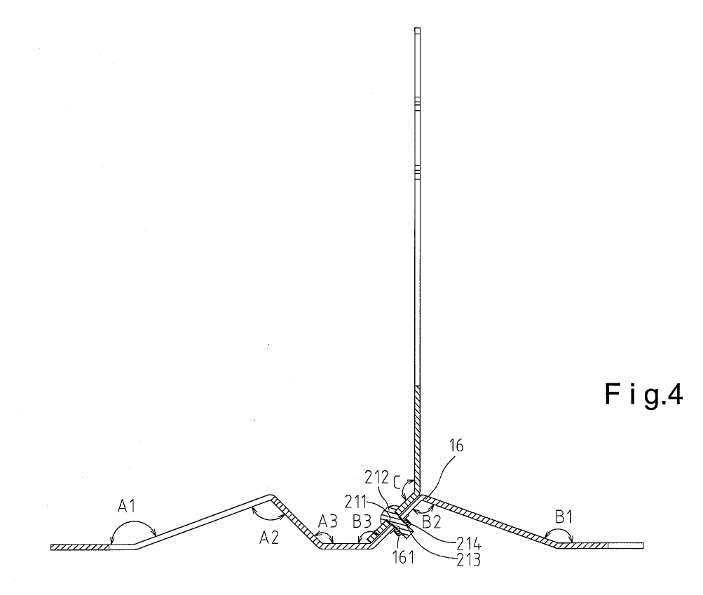

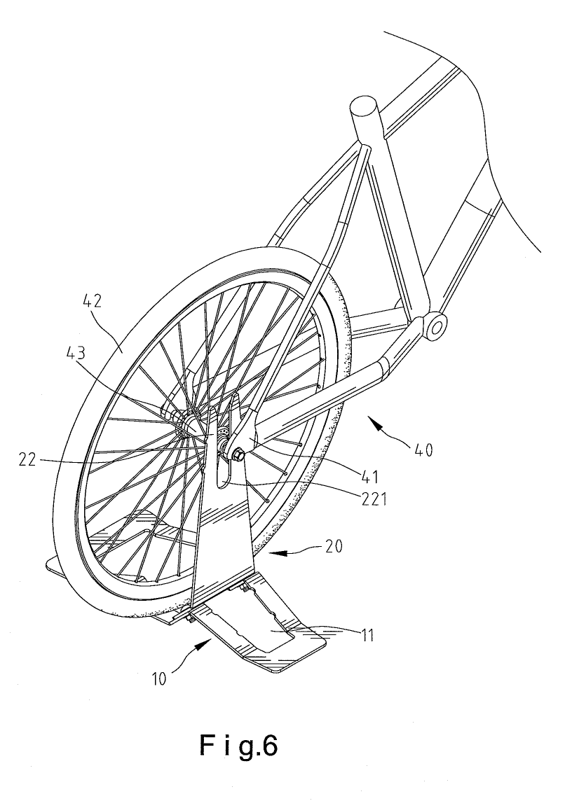

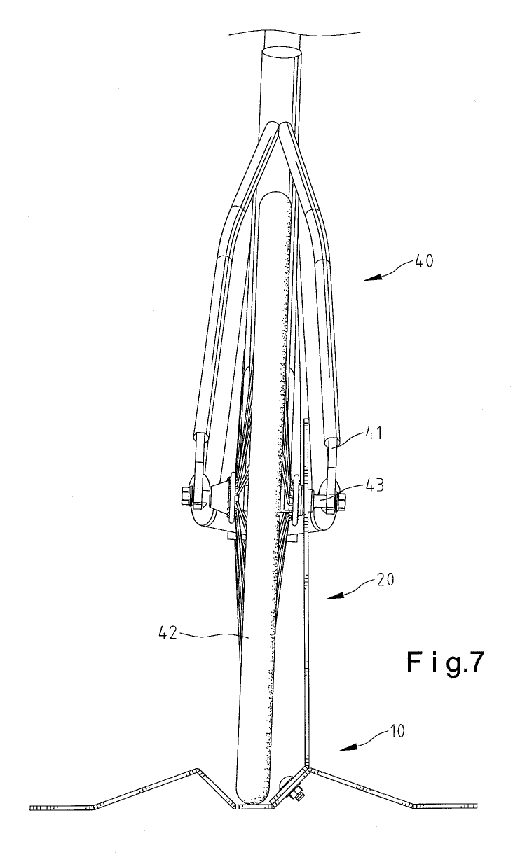

Referring FIGS. 1 through 4, a bicycle parking rack includes a base member 10 and a support member 20. The base member 10, which is adapted for holding a wheel 42 of a bicycle 40, is provided on the ground and has first and second ends (shown in FIGS. 6 and 7). The support member 20, which is adapted for holding a wheel axis 43 of the bicycle 40, is engaged with the base member 10 in an upright position and between the first and second ends of the base member 10 (shown in FIGS. 6 and 7).

The base member 10 is formed from a long plate piece and has numbers of bents. A first flat portion 12 and a second flat portion 13 are respectively defined at the first and second ends of the base member 10 and attach the ground. The base member 10 has a tapered-width profile from the first end to the second end thereof. A third flat portion 14 is defined at the center of the base member 10 transversely and attaches the ground and between the first and second flat portions 12 and 13. A first bent portion 15 is formed between the first and third flat portions 12 and 14 and has first and second straight sections 151 and 152. The second straight section 152 and the first flat portion 12 define an angle A1. The first straight section 151 and the second straight section 152 define an angle A2. And the first straight section 151 and the third flat portion 14 define an angle A3. The angles A1, A2 and A3 are all obtuse. A second bent portion 16 is formed between the second and third flat portions 13 and 14 and has first and second straight sections 161 and 162. The second straight section 162 and the second flat portion 13 define an angle B1. The first straight section 161 and the second straight section 162 define an angle B2. And the first straight section 161 and the third flat portion 14 define an angle B3. The angles B1, B2 and B3 are all obtuse.

A long hollow portion 11 is provided on the first and second bent portions 15 and 16 of the base member 10 longitudinally without penetrating the first and second ends of the base member 10.

The width of the first flat portion 12 is larger than the width of the second flat portion 13 so that the contact area of the first flat portion 12 with the ground is lager than the contact area of the second flat portion 13 with the ground. Moreover, the support member 20 is adapted for detachably coupling to the first straight section 161. Further, the angle A1 is larger than the angle A2, and the angle B1 is larger than the angle B2 so that the gradient of the second straight section 152 is greater than that of the first straight section 151, and the gradient of the second straight section 162 is greater than that of the first straight section 161. Hence, while the support member 20 is coupled to the base member 10 and the bicycle is maintained on the bicycle parking rack, the fore-mentioned features can keep balance of the base member 10 on the ground.

The support member 20 includes a coupled portion 21 formed on a first end thereof and detachably coupling to the first straight section 161 and a holding portion 22 formed on a second end thereof and extending from the coupled portion 21. The holding portion 22 is perpendicular to the flat portions 12, 13 and 14. The support member 20 is made from one-piece plate material, and the coupled portion 21 and the holding portion 22 define an obtuse angle C. In addition, the gradient of the coupled portion 21 is same to the gradient of the first straight section 161 so that the first straight section 161 and the coupled portion 21 abut against each other while the support member 20 is coupled to the base member 10. Two apertures 163 are defined on first straight section 161 and respectively adjacent to two sidewalls of the hollow portion 11. Two coupled holes 211 are formed on the coupled portion 21 and respectively corresponds to the apertures 163. In this embodiment, each aperture 163 is preferably circle and each coupled hole 211 is preferably square. Cooperation of two engaging elements 212, two nuts 213 and two washes 214 is adapted for engaging the apertures 163 with the coupled holes 211 as to couple the support member 20 to the base member 10. In this embodiment, each engaging element 212 is preferably a carriage bolt.

The holding portion 22 includes a slot 221 formed on and open to the distal of the second end of the support member 20 as to form the holding portion 22 to be U-shaped. Numbers of the protrusions 222 protrudes from the outer periphery of the second end of the support member 20. The slot 221 is adapted for receiving the wheel axis 43 of the bicycle 40. The holding portion 22 is preferably covered by or enclosed in a resilient sheath (not shown) to prevent marring of the bicycle finish. The sheath can be in the form of a U-shaped resilient tube that is slipped onto the holding portion 22. Further, the protrusions 222 are adapted for preventing the sheath from easily detaching from the holding portion 22.

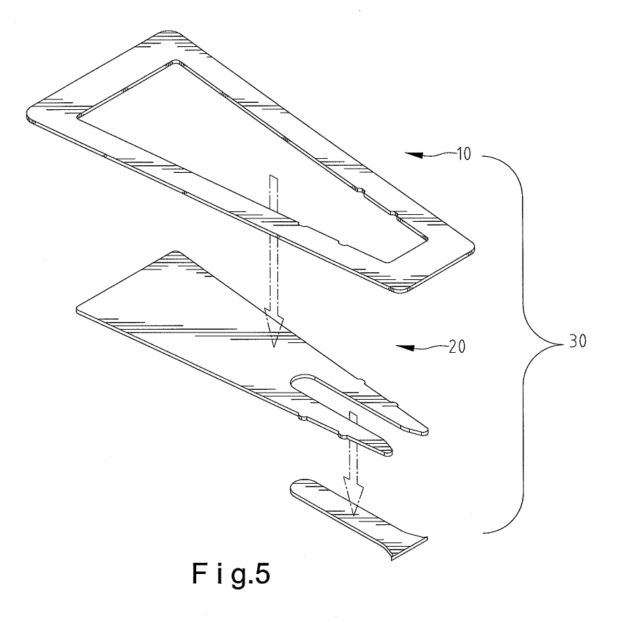

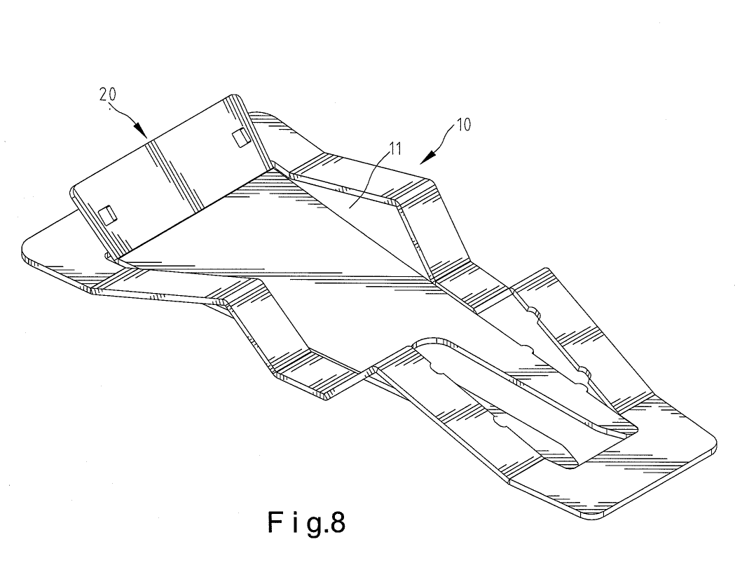

Referring to FIG. 5, it shows that a plate 30 is provided to be pressed for producing models of the base member 10 and the support member 20. It can save space and cost of materials and transport. While the model of the support member 20 is produced via pressing the model of the base member 10, the hollow portion 11 of the model of the base member 10 simultaneity is formed so that the profile of the hollow portion 11 corresponds exactly with the profile of the model of the support member 20. In this embodiment, the plate 30 is preferably metal plate. The hollow portion 11 allows that the model of the base member 10 is easy to be further pressed to form the first and second bent portions 15 and 16 thereon. It can save manufacturing cost. Further referring to FIG. 8, when the bicycle parking rack is not in use, the support member 20 can be detached from the base member 10 and received in the hollow portion 11 of the base member 10. Therefore, the volume of the bicycle parking rack is reduced as to decrease the transport cost. Moreover, the bicycle parking racks could not be easy to be pressed to deform by each other in transport.

Referring to FIGS. 6 and 7, they show that while parking the bicycle 40 onto the bicycle parking rack, the wheel 42 is located on the third flat portion 14 of the base member 10 and the wheel axis 43, which connects to chain stay 41 of the bicycle 40, is disposed in the slot 221 of the support member 20. In the same time, the bicycle 40 is slightly tilted toward the support member 20.

Deliberative but not limiting descriptions of the embodiment of the present invention have been made. However, it should be understood that the technical staffs in this field may make changes and/or modifications without being away from the related scope of protection as defined in Claims.

What is claimed is:

1. A metal bicycle parking rack comprising:
a metal base member provided on the ground and including a first flat portion and a second flat portion respectively defined at first and second ends thereof and attach the ground and a third flat portion defined at the center of the base member 10 and attaches the ground and between the first and second flat portions, and with a wheel of a bicycle disposed on the third flat portion;
a metal support member including a coupled portion formed on a first end thereof and detachably coupling to the base member and a holding portion formed on a second end thereof and extending from the coupled portion, and with the coupled portion provided between the first and second flat portions; and
numbers of engaging elements adapted for engaging the coupled portion with the base member.

2. The bicycle parking rack as claimed in claim 1, further comprising a first bent portion formed between the first and third flat portions a second bent portion is formed between the second and third flat portions.

3. The bicycle parking rack as claimed in claim 2, wherein the first bent portion has first and second straight sections and the second bent portion has first and second straight sections, with the second straight section and the first flat portion defining an angle A1, with the first straight section and the second straight section defining an angle A2, with the first straight section and the third flat portion defining an angle A3, with the second straight section and the second flat portion defining an angle B1, with the first straight section and the second straight section defining an angle B2, and with the first straight section and the third flat portion defining an angle B3

4. The bicycle parking rack as claimed in claim 3, with the angles A1, A2, A3, B1, B2 and B3 being all obtuse.

5. The bicycle parking rack as claimed in claim 2, further comprising a long hollow portion provided on the first and second bent portions of the base member longitudinally without penetrating the first and second ends of the base member.

6. The bicycle parking rack as claimed in claim 5, further comprising two apertures defined on first straight section and respectively adjacent to two sidewalls of the hollow portion and two coupled holes formed on the coupled portion and respectively corresponding to the apertures as to couple the support member to the base member.

7. The bicycle parking rack as claimed in claim 6, further comprising two engaging elements, two nuts and two washes adapted for engaging the apertures with the coupled holes as to couple the support member to the base member.

8. The bicycle parking rack as claimed in claim 1, wherein the base member has a tapered-width profile from the first end to the second end thereof; wherein the width of the first flat portion is larger than the width of the second flat portion.

9. The bicycle parking rack as claimed in claim 1, wherein the holding portion includes a slot formed on and opens to the distal of the second end of the support member for receiving a wheel axis of the bicycle.

10. The bicycle parking rack as claimed in claim 9, with the holding portion being U-shaped.

11. The bicycle parking rack as claimed in claim 9, further comprising numbers of the protrusions protruding from the outer periphery of the second end of the support member and adapted for preventing a sheath from easily detaching from the holding portion.

12. The bicycle parking rack as claimed in claim 1, wherein models of the base member and the support member are produced via pressing a metal plate, and with the profile of the hollow portion corresponding exactly with the profile of the model of the support member.

13. The bicycle parking rack as claimed in claim 1, wherein when the bicycle parking rack is not in use, the support member can be detached from the base member and received in the hollow portion of the base member.

14. The bicycle parking rack as claimed in claim 12, wherein when the bicycle parking rack is not in use, the support member can be detached from the base member and received in the hollow portion of the base member.
